(19) United States
(12) Patent Application Publication
(10) Pub. No.: US 2003/0229560 A1
(43) Pub. Date: Dec. 11, 2003

(54) Method for investor disclosure

(76) Inventors: James Donald Bourassa, Elgin, IL (US); Francis Xavier Sanchez, Woodstock, IL (US)

Correspondence Address: MCANDREWS HELD & MALLOY, LTD, 500 WEST MADISON STREET, SUITE 3400, CHICAGO, IL, 60661

(21) Appl. No.: 10/420,410

(22) Filed: Apr. 22, 2003

Related U.S. Application Data
(60) Provisional application No. 60/374,330, filed on Apr. 22, 2002.

(51) Int. Cl. G06F 17/60

(52) U.S. Cl. 705/36

(57) ABSTRACT

An investor disclosure system that provides a method for disclosing corporate operations to investors in real-time. Essential investing information such as the mission statement, sales and marketing plans, and financial metrics, are distilled and transmitted to the investor in an easily understandable, visual format, along with relevant live captured images of the corporation's operations. The invention gives the investor the ability to assess operational effectiveness, evaluate financial strength, monitor the performance of management, and determine the credibility of the corporation, as well as electronically communicate with corporate management. The preferred embodiment of the present invention also includes the ability for the investor to access their personal account information in real-time.

### RELATED APPLICATIONS

This application claims priority from U.S. Provisional Application Serial No. 60/374,330, filed Apr. 22, 2002, entitled “Method For Realtime Investor Oversight”.

### BACKGROUND OF THE INVENTION

The present invention pertains to the field of investing, and more particularly, to a process of disclosing information of corporate activities to an investor. Traditionally, investment is the commitment of present funds for the purpose of deriving a future return in the form of income.

Trust by the American investing masses has made U.S. equity markets the largest, deepest and most liquid in the world. That trust has been engendered largely by a regulatory framework based on the premise that full and fair disclosure of a corporation's business and financial status produces an honest market.

However, historically, concerns regarding the credibility and adequacy of financial reporting have caused skepticism amongst investors as to the fairness of the U.S. securities markets. While corporate and financial regulations such as the Securities Act of 1933, the creation of the Securities and Exchange Commission (“SEC”) in 1932, and Regulation S-K were intended to facilitate public faith in capital markets, and to create the assumption that corporations will accurately disclose all information necessary for investors to make an informed decision regarding the purchase or sale of securities, investors have remained justifiably skeptical.

In the 1970s, the inclusion of “soft” projections in SEC filings became a permissible practice. These once banned projections allow corporations to provide forward-looking information that is often an optimistically favorable forecast. In 1980, the Management Discussion and Analysis Requirement made the inclusion of such forward-looking “soft” information in filings a requirement. In 1995, Congress passed the Private Securities Litigation Reform Act, which improved safe harbor guidelines that protected executives making such forward-looking statements in instances where those statements are accompanied by meaningful cautionary language. Furthermore, these safe harbors require that investors bringing suit based on incorrect forecasts prove that the forecasts were purposely misleading.

Currently, not all disclosure is mandatory. Based on the premise that the more useful information that investors have, the lower the corporation's cost of capital, corporations can gain investor relations credibility by voluntarily disclosing a range of information, varying from performance measurements used to run the business to data pertaining to intangible assets that are not recognized in financial statements.

Today, investors are clamoring for even more information. Most Chief Disclosure Officers are intimately aware of the ever more complex nature of disclosure requirements and restrictions. Internationalism, technology, and changes in the investor community have shaped disclosure practices.

All of the presently available investor disclosure methods suffer from a number of disadvantages. For example, current investor disclosure is highly tailored to what the corporation feels the investor wants to see. Furthermore, current investor disclosure methods do not make the investor aware of all the factors that must be weighed in corporate decisions, and current investor disclosure is difficult for the non-financial specialist to understand. Investors also rarely have the time or opportunity to observe, in real-time, corporate operations, the corporation's current financial status, or to interact with corporate officials.

It is therefore an object of this invention to provide an improved method for investor disclosure of corporate operations.

It is therefore another object of this invention to provide reality-based investor disclosure information in real-time.

A further object of this invention is to provide investors with the ability to obtain a greater understanding and awareness of a corporation's position and current financial status, thereby empowering investors to think like owners.

Another object of this invention is the ability of the investor to digitally submit feedback to, and receive correspondence from, a corporation's management.

These and other desirable characteristics of the present invention will become apparent in view of the present specification, including the claims and drawings.

### SUMMARY OF THE INVENTION

The present invention is directed to a method of disclosing corporate operations to investors or potential investors (“investors”) in real-time. More specifically, the present invention is related to a method of disclosing information and captured images of corporate operations, transmitting the information to investors, and providing investors with the opportunity to access the information and captured images in real-time, along with the ability to digitally communicate with corporate management.

The present invention provides investors with the ability to, in real-time, assess operational effectiveness, evaluate financial strength, monitor the performance of management, and determine the credibility of the corporation's representations. The present invention is also capable of providing investors with the opportunity for open book management, whereby the investor may access, in real-time, current financial statements, including balance sheets, income statements, cash-flow statements, along with sales, marketing, capital, inventory, and compensation plans and organizational chart.

The method includes using capturing technology, including, but not limited to, web cameras, digital cameras, PDA devices, robot cams, or any digital image-capturing or digital converting device, to capture a continuous stream of captured images over pre-designated time-based intervals. The captured images are transmitted to the investor so that the investor may receive the information via, but not limited to, a digital network, the Worldwide Web or Internet, personal computers, televisions, PDA devices, wearable computers, cellular phones, and virtual reality interfaces. An interface menu presents investors with disclosure links that allow investors to focus on specific areas of interest.

The interface menu also provides investors with the opportunity to use the digital technology to provide feedback to, and establish correspondence with, corporate management regarding matters such as the received captured images and associated information. Likewise, corporate management may notify or respond to investors using the associated digital technology.

### BRIEF DESCRIPTION OF THE DRAWINGS

For a more complete understanding of this invention, reference should now be had to the embodiment illustrated in greater detail in the accompanying drawings and described below by way of example of the invention.

FIG. 1 is a flow chart showing the input, processing, and output of corporate information and captured images in accordance with an embodiment of the invention.

FIG. 2 is a block diagram showing an interface menu in accordance with an embodiment of the invention.

FIG. 3 is a flow chart showing the input of company operation information, the functions of the Chief Disclosure Officer, and the outputted information.

### DETAILED DESCRIPTION OF THE ILLUSTRATED INVENTION

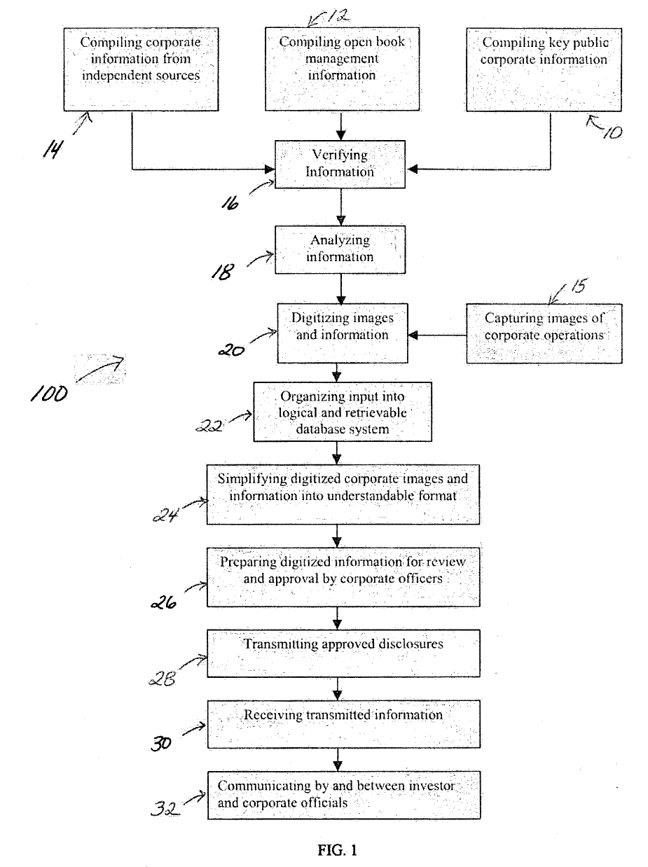

FIG. 1 illustrates an investor disclosure system 100 for obtaining and presenting corporate information and captured images to investors in real-time. Key public corporate information 10, such as, but not limited to, quarterly and annual reports, financial statements, core business, industry, cash position, off-balance sheet activities, legal proceedings, and contingent liabilities are compiled for possible disclosure in the system 100. This information may be found and compiled in a variety of forms, including digital and paper-based formats.

In the preferred embodiment of the present invention, the system 100 also contains a compilation of non-key public corporate information for full disclosure, such as open book management information 12. Open book management information 12 may include information such as government filings, including Securities and Exchange Commission, Internal Revenue Service, and Environmental Protection Agency filings. The open book management information 12 may also include, but is not limited to, officer information, history, mission & vision statements, officer statements, competition analysis, press releases, employee/union overviews, information on other corporate locations, corporate communication to employees, and customer feedback.

The system 100 may also provide the investor with access to information regarding the corporation that was created or compiled by independent third-party sources 14. Similar to key public corporate information 10 and open book management information 12, independent third party information 14 may be collected in various forms, including digital and paper based-formats. Information from third-party sources 14 may be obtained from television, radio, newspapers, the Worldwide Web or Internet, and may also include outsider opinions and analysis of the corporation, industry rumors, complaints, industry indicators, and corporate rankings from sources such as Dun & Bradstreet, BBB, Bloomberg L. P., and Fortune 500.

Once the relevant information for the investor disclosure system 100 is compiled, but prior to disclosure to the investor, the corporate information 10, 12, 14 undergoes verification 16. During verification, the corporate information is analyzed for accuracy, and may undergo standard appraisal methods in which inaccurate or misleading information is discarded. Although the preferred embodiment of FIG. 1 illustrates the verification 16 process as following the compilation of information 10, 12, 14, the verification 16 process may be performed at any time prior to disclosure to the investor.

With the goal of presenting only key facts while still providing all information necessary for the investor to make an informed decision regarding the purchase and sale of securities, the preferred embodiment of the present invention includes analyzing 18 the corporate information. The process of analyzing 18 the relevancy of the compiled information may also occur simultaneously or prior to the information undergoing verification 16. In the preferred embodiment, the analyzing 18 process eliminates all irrelevant and non-critical information prior to the disclosure to the investor.

In addition to compiling information 10, 12, 14, the investor disclosure system 100 also allows the investor to view captured images of corporation operations in real-time. Such captured images may be obtained through the use of capturing technology 15, including, but not limited to, web cameras, digital cameras, PDA devices, robot cams, or any digital image-capturing or digital converting device, and may be recorded in a variety of forms, including, but not limited to, analog or digital formats. The capturing technology 15 captures a continuous stream of captured images over pre-designated time-based intervals. In the preferred embodiment of the present invention, these continuous captured images provide the investor with the opportunity to regularly update, at the investor's convenience, the current status of corporate operations in real-time by downloading or printing the captured images 15.

A captured image not only allows the investor to observe real-time corporate operations for investment related purposes, but also allows the corporation to oversee its own operations. Such images allow the corporation the opportunity to address on a real-time live basis the concerns, questions or problems that a branch, franchise or affiliate has by being able to actually see what the problem is via the capturing technology. The company can then direct an immediate solution to any problem after reviewing the live information. The corporation may also use this real-time information for training purposes.

Once all of the corporate information has been compiled, information or captured images not already in a digital format may undergo digitizing 20. Digitizing 20 may occur with the use of devices such as, but not limited to, a scanner or translator, whereby printed, filmed, or spoken information is converted or processed into a digital format for computer storage, access, modification, or re-usability, and which is capable of being transmitted to an investor. Although FIG. 1 illustrates the digitizing 20 process occurring after verifying 16 and analyzing 18, digitizing 20 may occur simultaneously with or prior to verifying 16 and analyzing 18, as would be appreciated and understood by those skilled in the art. Once digitized, the compiled information 10, 12, 14 and captured images 15 may be uploaded to a target location, such as a computer network server.

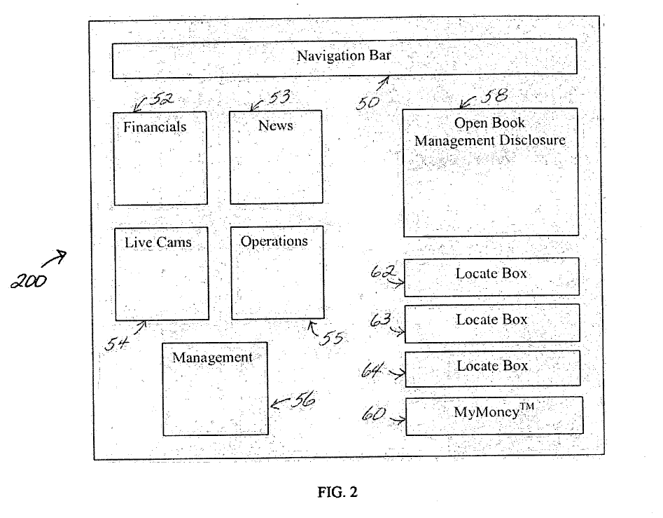

The compiled corporate information and captured images may also undergo organizing 22, whereby the information and captured images are incorporated into a logical and retrievable database. Depending on whether the organizing 22 of the compiled information occurs prior to, simultaneously with, or subsequent to digitizing 20, this database may be in a digital or paper-based format. Organizing 22 may also aid in arranging the investor disclosure interface menu 200, as depicted in FIG. 2 and discussed hereinafter, in a user-friendly format.

If necessary, the compiled information and captured images may also undergo a simplification 24, whereby the information or captured images are simplified in a manner, such as a logical database, that is readily understandable by the investor. In the preferred embodiment, the format of the visual presentation of the logical database allows the investor to easily navigate and comprehend the investor disclosure menu 200 and associated corporate information.

Prior to investor disclosure, the preferred embodiment of the present invention also includes the review and approval 26 of the compiled information 10, 12, 14 and captured images 15 by corporate officials. Keeping with the spirit of the present invention, the goal of the reviewing and approval procedure 26 is not to censor information, but to present only key facts that are critical to understandable, true, and fair corporate disclosure. Although FIG. 1 illustrates the review and approval 26 procedure occurring after the digitized 20 information has undergone simplification 24, the review and approval procedure may occur at any time prior to investor disclosure, as will be understood and appreciated by one of ordinary skill in the art.

Once the compiled information and captured images are in condition for reception by the investor and have undergone any necessary verification 16, analysis 18, digitization 20, organization 22, simplification 24, and review and approval 26, that information and captured images are transmitted 28 for viewing by the investor.

The transmitted 28 disclosure information and captured images are then received 30 by the investor. The equipment necessary for investor reception 30 are dependent on the method of transmission 28, but may include, among other things, personal computers, televisions, PDA devices, Worldwide Web or Internet compatible devices, wearable computers, cellular phones, and virtual reality interfaces. Preferably, access to transmitted 28 information and captured images of corporate operations will also incorporate security measures that protect the privacy and security of the corporation's officers and employees.

The preferred embodiment of the present invention also includes communication 32 capabilities for the interactive communication 32 between investors and corporate officials and representatives. This communication 32 provides the opportunity for both real-time communication 32 and messaging so that the investor has the opportunity to provide corporate officials with both feedback regarding the transmitted information and captured images, along with the ability to participate in real-time conversations via, for example, an investor online chat room.

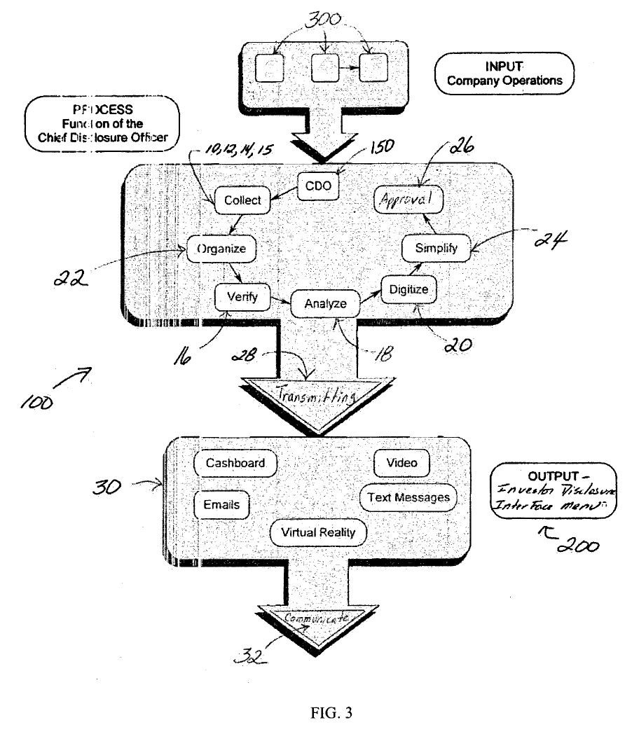

In the preferred embodiment of the present invention, disclosure of corporate information via the investor disclosure system 100 would be performed by, or under the direction of, a corporate employee or agent, such as a Chief Disclosure Officer 150 (“CDO”), as shown in FIG. 3. The CDO 150 is responsible for managing, updating, overseeing, and/or performing a variety of tasks necessary for full investor disclosure. The CDO 150 starts the process by collecting information from the universe of corporate information 300, and more specifically begins collecting or compiling key public corporate information 10, open book management information 12, information from independent sources 14 and captured images 15. Under the direction of the CDO 150, and in no particular order, the compiled information 10, 12, 14 and captured images 15 then undergo: organization 22; verification 16; analysis 18; digitizing 20; simplification 24; and review and approval 26 before being transmitted to the investor in the form of a logical database. Furthermore, the CDO 150 may receive feedback from, and interact with, the investor via, for example, an investor online chat room.

While the CDO 150 of the preferred embodiment of the present invention would be a full time employee or officer of the disclosing corporation, the CDO 150 position may also be filled by an out-sourced separate business entity.

FIG. 2 shows a block diagram of an electronic investor disclosure system interface menu 200 in accordance with the preferred embodiment of the present invention. The menu 200 provides investors with the option of accessing and viewing transmitted 28 corporate information and captured images using transmitting compatible technology including, but not limited to, Worldwide Web or Internet compatible devices, televisions, PDA devices, wearable computers, cellular phones, and virtual reality interfaces.

The menu 200 includes a navigation bar 50 that provides direct links to a variety of services and information. Because the interface menu 200 may be supported by the disclosing corporation or an outside contractor, the navigation bar may provide links to generalized information, such as services, research, products, support, reference, or contact information tailored to the services or business of the supporting entity.

The interface menu 200 of the preferred embodiment of the invention also includes a variety of corporate information links 52, 53, 54, 55, 56 that are related to the organization 22 of complied and transmitted 28 real-time corporate information and captured images. These information links 52, 53, 54, 55, 56 are tailored to specific areas of interest by the content of the information or captured images so that the investor may conduct an investigation directed at specific areas of interest. These areas of interest may pertain to, but are not limited to, corporate finances, news, operations, and management along with real-time captured images. Furthermore, these information links 52, 53, 54, 55, 56 may direct the investor to multiple subcategories that provide the investor with the opportunity to conduct an even more focused investigation of the corporation's disclosures or select specific captured images from and variety of corporate operations.

The interface menu 200 of the preferred embodiment of the present invention also provides locate boxes 62, 63, 64. These locate boxes 62, 63, 64 provide the investor with a direct connection to an area of interest including, but not limited to, captured images from a specific capturing device or to the interface menu 200 of a different corporate entity without having to proceed through the information links 52, 53, 54, 55, 56 and any associated subcategories.

The preferred embodiment also includes an open book management disclosure link 58 that provides corporate information including, but not limited to: a mission statement; financial statements such as balance sheets, income statements, and cash-flow statements; sales and marketing plans; the capital plan; the inventory plan; an organizational chart; and compensation plan.

An additional feature of the preferred embodiment of the current invention is an investor's information page 60. The Investor's information page 60 directs the investor to information pertaining to the investor's personal investments, finances, and/or investment portfolio. Using the Investor's information page 60, investors may evaluate personalized information such as, but not limited to, how much money is in the investor's account, terms and rates, stock ownership, and beneficiary designations.

While the present invention has been illustrated in some detail according to the preferred embodiment shown in the foregoing drawings and descriptions, it will be understood that the invention is not limited thereto, since modifications may be made by those skilled in the art, particularly in light of the foregoing teaching. It is therefore contemplated by the appended claims to cover such modifications that incorporate those features that come within the spirit and scope of the invention.

What is claimed is:

1. A method for disclosing corporate operational information and captured images that are obtained by a Chief Disclosure Officer to investors in real-time, comprising:
a. compiling a database of corporate information;
b. verifying the relevancy of the database of corporate information and discarding information that is irrelevant to full and fair disclosure of corporate operations;
c. analyzing the accuracy of the database of corporate information and discarding inaccurate information;
d. capturing a plurality of captured images of corporate operations in real-time;
e. digitizing any non-digital information contained in the database of corporate information and any non-digitized plurality of captured images;
f. organizing the database of corporate information and the plurality of captured images into a logical database;
g. preparing the logical database for review and approval by at least one corporate official;
h. transmitting the logical database to at least one investor; and
i. receiving the transmission of the logical database by the at least one investor.

2. The method of claim 1 wherein the database of corporate information includes a database of key public corporate information.

3. The method of claim 1 wherein the database of corporate information includes a database of open book management information.

4. The method of claim 1 wherein the database of corporate information includes a database of independent third party information.

5. The method of claim 1 including transmitting investor feedback regarding information contained in the logical database to the at least one corporate official.

6. The method of claim 1 including transmitting interactive feedback communication between the at least one investor and the at least one corporate official in real-time.

7. A method for disclosing corporate operational information and captured images to an investor in real-time, comprising:
a. compiling a database of key public information;
b. compiling a database of open book management information;
c. compiling a database of independent third party information;
d. verifying the relevancy of the databases of key public information, open book management, and third party information and discarding information that is irrelevant to full and fair disclosure of corporate operations;
e. analyzing the accuracy of the databases of key public information, open book management, and third party information and discarding inaccurate information;
f. capturing a plurality of captured images of corporate operations in real-time
g. digitizing any non-digital information in the databases of key public information, open book management, and third party information and any non-digitized plurality of captured images
h. organizing the databases of key public information, open book management, and third party information and the plurality of captured images;
i. preparing the databases of key public information, open book management, and third party information and the plurality of captured images for review and approval by at least one corporate officer;
j. transmitting the databases of key public information, open book management, and third party information and the plurality of captured images to the investor;
k. receiving the transmission of the databases of key public information, open book management, and third party information and the plurality of captured images by investor; and
l. providing interactive communication regarding the received information in the databases of key public information, open book management, and third party information and the plurality of captured images between the at least one corporate officer and the investor.

8. A method for disclosing a plurality of captured images of corporate operations so that an investor may have access to full and fair disclosure of corporate activities to aid the investor's ability to make an informed decision regarding the purchase and sale of securities, comprising:
a. capturing the plurality of captured of corporate operations in real-time using capturing technology;
b. digitizing any non-digital images of the plurality of captured images;
c. uploading the plurality of captured images to a target location; and
d. transmitting the plurality of captured images to the investor.

9. A method for corporate disclosure that allows an investor to view the application of the investor's investment funds on a real-time basis by digitalizing key financial information as well as actual corporate operations, comprising:
a. accessing an investment disclosure system interface menu;
b. accessing the investor's investment page from the investment disclosure system interface menu, the investor's investment page containing regularly updated individualized account and investment information;
c. accessing and viewing captured images from the system interface menu;
d. monitoring the progress of financial projections by matching actual projections to actual project status as viewed live by captured images and the investor's investment page; and
e. maintaining a digital record of the history of corporate operations, the digital record being obtained by saving captured images, the investor's investment page, or archived corporate digital records.

10. The method of claim 9 including evaluating the captured image for corporate training and monitoring purposes.

11. The method of claim 9 wherein maintaining a digital record of the history of corporate operations involves printing captured images, the investor's investment page, or archived corporate digital records.

12. A method for providing an investor with immediate corporate financial and operational information and allowing the investor to submit and receive feedback via digital transmissions, comprising:
a. observing in real-time corporate operations, meetings, and agreements;
b. verifying the representations in the observed real-time corporate operations, meetings, and agreements with information presented on an investor disclosure system interface menu; and
c. providing the Chief Disclosure Officer with real-time feedback regarding the result of verifying the representations of the real-time corporate operations, meetings, and agreements with the representations on the information presented on an investor disclosure system interface menu.

13. The method of claim 12 including utilizing the investor feedback to correct a representation in the observed real-time corporate operations, meetings, and agreements.

14. A method of monitoring and creating a digital record of corporate operations, comprising:
a. positioning cameras at key financial and core business operations and capturing images of those key financial and core business operations;
b. observing in real-time events at core business operations; and
c. reacting to the observed events and activities by contacting those that are involved in the matter at hand.
